(19) United States
(12) Patent Application Publication
(10) Pub. No.: US 2005/0195457 A1
(43) Pub. Date: Sep. 8, 2005

(54) Process and apparatus for the application of diffractive elements upon surface areas

(76) Inventor: Peter Schmitt, Wurzburg (DE)

Correspondence Address: MORGAN & FINNEGAN, L.L.P., 3 WORLD FINANCIAL CENTER, NEW YORK, NY, 10281-2101, US

(21) Appl. No.: 11/064,656

(22) Filed: Feb. 23, 2005

(30) Foreign Application Priority Data
Feb. 24, 2004 (DE) 10 2004 009 422.5

(51) Int. Cl. G03H 1/00

(52) U.S. Cl. 359/35; 430/1

(57) ABSTRACT

The invention relates to a process for the manufacture of diffractive elements, especially holograms, on the surface of an object, whereby holographic information is transferred onto a photosensitive recording layer applied on the surface, especially by exposure, whereby in a repetitive manufacturing process diffractive elements to be produced in succession are varied by modifying the configuration of the transferable holographic information and/or by changing the configuration of the photosensitive recording layer on the surface. The invention further relates to an object with at least one diffractive element, in particular a holographic marker, as well as an apparatus for the production of such an object.

The invention relates to a process for the manufacture of diffractive elements, particularly holograms, on the surface of an object, whereby holographic information is transferred, especially by exposure, onto a photosensitive recording layer coated on the surface. The invention further relates to an object produced by such a process, as well as the apparatus for the implementation of the process.

The history of holography was founded on the work of Dennis Gabor, who was the first to elaborate and describe the basics. Nowadays, there are a number of derived processes utilizing the basic principle of holography, mutual interference of light waves, to produce special effects. The most widespread are the so-called rainbow holograms, produced by a special optical printing process from a master hologram.

True, this printing process essentially does away with one dimension of the spatial representation, but in exchange it gains a real surface hologram, which can be easily and economically reproduced with suitable embossing rollers, as a rule on plastic foil. The surface structures of the embossed holograms so produced are mostly coated with a metal film for greatly enhanced diffraction efficiency of the hologram. A further lacquer coating or sealing inside a laminate in a successive step protects the micro-structures so produced against external influences, and also, among other things, against unauthorized copying by duplicating techniques. The mentioned loss of the one spatial dimension, on the other hand, produces a rainbow effect, meaning that the observed image changes colors, depending on the viewing angle.

Such holograms or diffractive elements in general are used for example as scintillating packaging materials or labels. More complex structures, those that under different angles display additional different information, contain microtexts or portray sequences of motion, are used for example as safety markers on banknotes, personal I.D. documents or other products deserving of protection.

Nevertheless, all these holograms, and in particular the rainbow holograms, feature solely static holographic information, that is to say, information which cannot be individually matched to variable external data from one hologram to the next, particularly within a repetitive production process.

For the production of real holograms, such as needed for the preparation of masters, use is made of glass plates or foils coated with a photosensitive recording layer. By way of photosensitive substances, use is often made of silver halide emulsions known from photography, since the same are on the one hand readily available in commerce, and on the other, along with their elevated photosensitivity, they also display the fine granulation of silver salts.

The master hologram is produced in known configurations utilizing laser beams or, in the case of a computer-generated hologram, they are directly recorded with a suitable exposure unit onto the photosensitive layer. Such holographic exposure systems per se are known to the expert.

Now, following wet chemical development and fixation, the copies made of this master hologram in most cases already displays the mentioned rainbow effect. These copies are mostly produced in photosensitive thermoplastic materials with which it is possible to create surface structures. These surface structures are coated with conductive materials in a next following step and in a subsequent galvanic process nickel films of a thickness of a few 100 μm are deposited on the surface, now made conductive. The nickel plates so produced, known as shims, serve as embossing plates for the reproduction on an embossing press. It will be easily understood that the entire process up to the duplication of the holograms is costly and tedious, permitting no individualized or personalized holograms, in that working with a predetermined master hologram, all subsequent copies are necessarily identical.

As an alternative to the described silver halide films, there are photopolymers which also lend themselves to the production of holograms by reason of their composition, consisting essentially of monomers, oligomers, photoinitiators and sensitizing materials. Such polymers and ready-made films are for example produced and marketed by the DuPont company.

The production of a hologram utilizing such polymers takes place in such a way that the polymer layer is exposed to light of a suitable wave length in an appropriate holographic arrangement. A laser beam is usefully employed to this end on account of its elevated optical efficiency, high monochromatism and the requisite coherence length. The maximum spectral sensitivity of these polymers, depending on their composition and possible sensitization, lies in the ultraviolet, blue, green or red range of the optical spectrum. Hence, use may be made for example of the argon ion laser, krypton ion laser, ruby laser, helium-neon laser, metal vapor laser and also frequency-doubled neodymium YAG laser, or in general, frequency-multiplied infrared lasers, as they are commercially available. Use may also be made of diode lasers. The chosen laser may work in continuous operation or in pulsed operation, which merely necessitates adjusting the exposure parameters within the arrangement.

By reason of the spatially modulated wave front impacting the polymer layer in the course of holographic recording, the exposure is not uniform at every point of the polymer layer, so that points or areas of intensive exposure occur alongside areas of limited exposure. In the areas of intensive exposure, the incident beam causes incipient polymerization of the monomers, thereby creating a monomer concentration drop-off from the unexposed to the exposed spots.

Because of the concentration drop-off, the monomers migrate to the areas of intensive exposure, causing local changes in the refraction index of the layer identical to the spatially modulated wave front, constituting a so-called phase hologram.

Complete polymerization with diffuse, non-coherent UV light following the end of exposure fixes this condition lastingly. Beyond that, in a next following step, the hologram so obtained may be stored for a given period of time in an oven at a higher temperature, further enhancing the refraction index differential between the previously exposed and unexposed areas, leading to an increased angle of diffraction. This process is also known as tempering.

This process is already employed in suitable machines for the duplication of holograms. However, once again the main drawback is that merely identical copies of a master hologram are reproduced. The master hologram itself is produced conventionally in an optical laboratory.

The task of the invention is to create a process for the production of individualized and/or personalized diffractive elements, for ex. holograms, without having to rely on the production or use of hologram patterns such as master holograms, shims, etc. The task is also to make available suitable apparatus for the implementation of the process and to provide as simply and economically as possible objects with individually variable diffractive elements.

The task is solved in that diffractive elements sequentially produced in a repetitive manufacturing process are varied by modifying the holographic information to be transferred onto the recording layer and/or by changing the configuration of the photo-sensitive recording layer on the surface.

Hence, there are two methods, possibly used in combination, to ensure variability of diffractive elements, for ex. of a hologram.

With this process, it is possible within a continuously working manufacturing process to produce variable and individualized or personalized diffractive elements, for ex. holograms, whereby the variability may rest for one thing on the structure of the hologram, that is, on the information embedded in the recording layer.

For another thing, the recording layer may have a configuration differing from object to object applied, or to be applied, thereon, whereby the variable configuration of the recording layer may constitute changeable information. The two types of variability may also be combined the one with the other.

In relation to the recording layer, it should be noted that the same may be applied to the objects, for example, in a preliminary manufacturing sequence and that it may be either identical in each case of varied from object to object. Thus, in the next following process according to the invention, for example with an always identical configuration of the recording layer on the object, an ever changeable information may be exposed holographically onto the recording layer in order to achieve variability.

In the case of recording layer configurations varying from object to object, the information exposed onto the recording layer may always be the same, or the information may also vary from object to object.

In the process, it is also possible to expose the recording layer just immediately prior to the holographic transfer of information onto the surface of an object.

The change of the transferable holographic information may preferably be accomplished by changing at least one holographically transferable variable object pattern, especially where the change of the object pattern is computer generated.

Thus, a variable object pattern may be exposed onto the recoding layer in a customary exposure pattern with object beam and reference beam, where the two beams interfere.

Similarly, the interference pattern to be exposed may be originally computer-generated and exposed onto the recording layer even without physical interference actually taking place. Computer-generated variability is ensured in that a re-programmable interference pattern may always be produced and embedded in the recording layer.

In the process, the variable information to be exposed may at all times be produced, for example, by a computer system in the shape of images, texts or machine-readable codes or machine-readable holograms in the form of a hologram.

In the case of a variable object pattern, this may involve any object capable for example of automatic and especially computer-assisted variation of its optical appearance, hence for example a programmable visual indicator device, especially a liquid crystal indicator.

The information actually displayed in the exposure process in the visual indicator is then taken over in the diffractive element. Thus, for example, it is possible to transfer in a sequence of diffractive elements to be produced continuously changed image/text information, in particular continuous numbering.

As previously mentioned, a photosensitive recording layer may be applied onto the surface of an object during the production process, prior to the transfer of holographic information. This may involve an inner and/or outer surface of the object, whereby in the case of an inner surface the overlying material should preferably be transparent, in order to facilitate exposure through this material onto the recording layer.

The recording layer may consist of typical silver halide compounds and/or contain a photopolymer as well. Provision may be made here for the applied recording layer to be mechanically fixed before surface exposure, for example to prevent a run of the layer. This may be accomplished for example by drying or evaporating of solvents, hardening of bonding agents etc.

Particularly preferable is to apply the photosensitive recording layer, especially a photo-polymer, by spraying, immersion and/or a printing process, in particular ink jet printing onto the surface of an object. Precisely in the use of printing processes, in particular ink jet printing, the configuration of the recording layer may readily be changed from one object to the next.

In changing both the configuration of the recording layer as well as the holographic information to be transferred from object to object, provision may furthermore be made for the information represented by the configuration of the recording layer to be correlated with the information holographically embedded in the recording layer. Thus, for example, the recording layer may be embossed in the form of text or images, whereby the same text and/or the same image are simultaneously exposed onto the recording layer.

By means of the process according to the invention, any object at will, in particular with any desired surface (plain or in relief) may be provided with diffractive elements virtually immune to counterfeiting.

An apparatus for the manufacture of an object with a diffractive element, in particular a holographic marking, may involve a printing press whereby a photosensitive recording layer is imprinted onto the surface of an object. Such a printing press may feature a holographic exposure unit whereby it is possible to transfer onto the applied recording layer holographic information, especially a variable object pattern.

In one embodiment, photosensitive polymers in particular may be applied as the recording layer onto the surface of any given object. Not unlike lacquers from the printing industry, such polymers may be processed in conventional printing presses, as for example flexo printing machines, offset printing presses, screen printing machines or tampon printing presses, etc.

These polymers may also be used the same as conventional ink jet colors in ink jet printers. To this end, the rheologic properties such as for ex. static and dynamic viscosity, scratch resistance etc. may be suitably adapted to the requirements of the chosen inkjet printer. This may be accomplished by the addition of reactive solvents, evaporative solvents, filler materials etc. Additionally, suitable pigments may be added to generate additional optical effects, such as for example fluorescence or phosphorescence.

In principle, the adapted polymers may be elaborated by all ink jet printing processes, such as continuous ink-jet or drop-on-demand ink jet. The manner of operation may be described as follows.

An object at will is imprinted with an ink jet printer using the above-mentioned polymer in lieu of the customary ink. The image is supplied to the ink jet printer by a computer system and suitable software. In this manner, texts, logos or pictures may be imprinted conventionally onto a surface. In a next following step, the information so imprinted is provided with hologram information in the manner described above, whereby the hologram information is opportunely correlated with the printed information.

Thus, for example, the same information may be recorded in the hologram, or different information correlated with the printed one via a mathematical algorithm or an optical system. This makes it possible to post upon the surface, for example of a personal ID document, freely programmable information in twin and interdependent fashion.

This makes it possible in a particularly simple and economical manner to coat with ink jet print, but also with other printing processes, different products as for example paper and plastic sheets, foil, Smart Cards, ID's, CD's or DVD's etc., whose coated surface can now serve as photosensitive recording media for a hologram. The hologram recording matches standard procedures, for example as reflexion hologram or transmission hologram, depending on the purpose and the material properties of the carrier.

To this end, the coated object is used as a “photo plate” for example in a customary holographic configuration in lieu of the conventional photo plate, to be suitably exposed for example by means of a laser beam, whereby it is immaterial whether the surface of the object is plane or curved, that is to say, spatially predetermined. In this way, even three-dimensional objects, for example, may be provided with holograms on their surfaces.

As an example, in this way it is possible to provide glass or plastic hollow bodies such as bottles or spheres, for example Christmas tree balls, with a hologram. To this end, the interior of a transparent glass or plastic hollow body is coated with polymer, whereby the polymer is simply infused through an existing opening in the hollow body and the inner wall is completely wetted by tilting. Any excess polymer is poured out through the opening for reuse.

Following evaporation of any solvent contained in the polymer, the hollow body is used as a photo plate in a holographic configuration, in order to display an object, for example a figure, or even simple diffractive structures, to create optical effects.

After exposure with the laser beam, next following is fixation with UV light and optional oven tempering to enhance diffraction efficiency. In order to further enhance the visibility of the hologram for the viewer, the interior of the hollow body may be additionally coated with a dark color in the customary manner.

Advantageous for the utilization of the polymer within the interior of the hollow body is the fact that the holographic layer inside the body is well protected against mechanical and chemical influences.

Independent of the concrete exemplified embodiment of the hollow body, the mentioned procedural steps may as well be employed in the described manner in any other desired object.

By utilizing for example a freely programmable LCD display as the object to be holographed, variable data may be transferred to the hologram in one production sequence, allowing personalization of the hologram.

For example, personalized real holograms may be produced by continuous numbering, individual names, images or even a combination thereof, by using several such displays. The source of beams used here, for ex. a laser (solid laser, semiconductor laser, gas laser) works in one embodiment in continuous operation. In that embodiment, a stable mechanical build-up of the exposure unit is called for. The reason is that a hologram constitutes a momentary image of a spatially modulated electromagnetic wave field, to be recorded within a photosensitive layer.

Such spatially modulated wave field, however, consists of areas of elevated light intensity and closely adjacent areas of low light intensity, whereby the separation of such areas lies in the range of half a wave length of the light used. That equals 266 nm when a laser emitting at 532 nm, a frequency-doubled neodymium YAG laser, is used. Now, if the photosensitive recording layer, in this case the photosensitive polymer, is located in the mentioned area of the wave field, then the areas of elevated light intensity trigger locally the start of polymerization. Now, if this were to occasion by reason of vibration or some other influence a displacement of the modulated wave field within the recording layer, this would also trigger in this case polymerization of adjoining areas which at this point in time should stay unpolymerized in order to produce a hologram, so that throughout the entire duration of exposure the polymer layer would be completely and, viewed microscopically, homogeneously exposed.

In such a case, no hologram would be stored in the polymer layer. The exposure times, and by the same token the times during which no displacement should take place, lie for a continuously operating laser customarily in the range of less than 1 second up to several minutes, which requires a stable and vibration-free mechanical layout for the production of holograms.

In another embodiment, the hologram is recorded by means of a brief light impulse in the photosensitive layer, which affords the advantage that the entire anti-vibration mechanical layout may be less sensitive than would be the case when using a continuously operating laser. By utilizing as brief as possible and intensive laser impulses, the aforementioned time during which no displacement or modification of the wave field is allowed, is naturally also reduced to the timing of the laser pulse. Accordingly, mechanical oscillations of a cycle greater than the duration of the laser pulse would trigger no changes in the wave field interfering with the production of the hologram.

The lasers used herein are for example those pumped by means of flash bulbs, so that a laser beam is essentially emitted only for the duration of the excitation flash on the laser-active medium in the laser. The duration of the laser pulse lies here in the range of 0.1 ms up to 10 ms. Shorter laser pulses may be achieved by the added use of a Q-switch which is either actively controlled or built as a passive element. Where the need is limited to small hologram surfaces, it is also possible to use continuous-pumped lasers whose output beam is pulsed with active Q-switches or passive Q-switches. In such an arrangement, it is possible to generate repetitive pulse frequencies of several 10's kHz, facilitating high-speed production.

Examples of active Q-switches are acoustic-optic modulators, Kerr cells or Pockels cells; examples of passive Q-switches are the so-called saturation absorbers in liquid or solid form. The duration of such laser pulses lies customarily in the range of 10 ns up 500 ns, so that the negative effect of vibration sis hardly noticeable any more.

This application claims priority from German Application No. 1004 009 422.5 which is hereby incorporated by reference herein.

1. A process for the production of diffractive elements, on the surface of objects, whereby holographic information is transferred onto a photosensitive recording layer applied onto the surface comprising varying a sequence of diffractive elements to be produced by modifying the holographic transfer information and/or by changing the configuration of the photo-sensitive recording layer on the surface.

2. A process according to claim 1, wherein the modification of the holographic transfer information is accomplished by changing at least one variable object pattern to be holographically transferred, whereby the object pattern change is computer-controlled.

3. A process according to claim 2, wherein the object pattern is a programmable indicator device.

4. A process according to claim 1 wherein for a sequence of diffractive elements to be produced, continuously changing picture or text information is transferred onto the recording layer.

5. A process according to claim 1, wherein a photosensitive recording layer is applied onto the surface prior to transferring the holographic information.

6. A process according to claim 5, wherein the photosensitive recording layer is applied onto an inner and/or outer surface of the object by spraying.

7. A process according to claim 1, wherein information represented by the configuration of the recording layer is correlated with the information holographically embedded in the recording layer.

8. A process according to claim 1 wherein information available on the object is correlated with information holographically embedded in the recording layer.

9. An object with at least one diffractive element applied onto the object according to a process according to claim 1.

10. (canceled)

11. An apparatus for the production of an object with a diffractive element whereby holographic information is transferable onto a photosensitive recording layer applied on the surface of the object comprising means for producing, in a repetitive manufacturing process a sequence of distinguishable diffractive elements.

12. An apparatus according to claim 11, comprising at least one printing unit whereby a photosensitive recording layer is imprinted onto the surface of an object.

13. An apparatus according to claim 12, wherein the printing unit, whereby a photosensitive recording layer is imprinted onto the surface of an object, is programmable.

14. An apparatus according to claim 12, wherein the printing unit includes a holographic exposure unit, whereby holographic information may be transferred onto the applied recording layer.

15. An apparatus according to claim 12, comprising at least one module for fixing the holographic information in the photosensitive recording layer.

16. A process according to claim 5, wherein the photosensitive recording layer is applied onto an inner and/or outer surface of the object by immersion.

17. A process according to claim 5, wherein the photosensitive recording layer is applied onto an inner and/or outer surface of the object by ink jet printing.
